(19) United States
(12) Patent Application Publication
(10) Pub. No.: US 2016/0358287 A1
(43) Pub. Date: Dec. 8, 2016

(54) Apparatus and Method for Medical Information Exchange Consent Policy Data Filtering

(71) Applicants: Marc Willard, San Jose, CA (US); George Morris, Los Gatos, CA (US); Yogesh Lokhande, Fremont, CA (US); Siva Gaddam, San Jose, CA (US); Adam Veres, San Carlos, CA (US)

(72) Inventors: Marc Willard, San Jose, CA (US); George Morris, Los Gatos, CA (US); Yogesh Lokhande, Fremont, CA (US); Siva Gaddam, San Jose, CA (US); Adam Veres, San Carlos, CA (US)

(73) Assignee: Certify Data Systems, Inc., San Jose, CA (US)

(21) Appl. No.: 13/587,728

(22) Filed: Aug. 16, 2012

Related U.S. Application Data
(63) Continuation-in-part of application No. 12/893,384, filed on Sep. 29, 2010.

(51) Int. Cl. G06Q 50/24

(52) U.S. Cl. CPC G06Q 50/22

(57) ABSTRACT

An electronic medical record system includes a first electronic medical record system to store a complete medical record for a patient. An electronic medical record appliance is connected to the first electronic medical record system. The electronic medical record appliance includes a medical information exchange consent policy module including instructions executed by a processor to supply to the patient a medical information exchange consent policy interface with selectable medical information exchange consent policy elements, receive selected medical information exchange consent policy elements from the patient, accept from a second electronic medical record system a medical record request for the patient, filter the complete medical record for the patient in accordance with the selected medical information exchange consent policy elements to form a consent filtered medical record and transfer the consent filtered medical record to the second electronic medical record system.

### CROSS-REFERENCE TO RELATED APPLICATION

This application is a continuation-in-part of U.S. patent application Ser. No. 12/893,384, filed Sep. 29, 2010.

### FIELD OF THE INVENTION

This invention relates generally to electronic medical records. More particularly, this invention relates to a medical information exchange consent policy data filtering technique.

### BACKGROUND OF THE INVENTION

An electronic medical record is a collection of health information in electronic form. The health information may relate to an individual's medical history, medications consumed, allergies, immunization status, laboratory test results, radiology images, billing information and the like. An electronic medical record (EMR) is sometimes referred to as an electronic health record (EHR), electronic patient record (EPR) or computerized patient record.

EMRs are used to facilitate the automation and streamlining of the workflow in health care settings. In addition, it is a goal to use EMRs to improve healthcare through evidence-based decision support, quality management and outcome reporting. While this is a laudable goal, it remains illusive in view of the capital costs, training costs and maintenance costs of new systems.

Legacy systems are typically incompatible with one another. For example a physician's office may have a first legacy system that is incompatible with a second legacy system at a hospital. Consequently, a doctor that works at both the physician's office and the hospital may not be able to exchange records between these two venues. In other words, the doctor may be able to use the first legacy system at the physician's office and the second legacy system at the hospital, but the two systems operate in separate silos and are otherwise not integrated.

A central data server may be used to store the different records, but this represents an entirely new system with significant capital costs. In addition, there are challenges associated with normalizing disparate records and then loading them into a single repository. This solution also raises confidentiality concerns.

It is desirable to allow health care professionals to continue to use their legacy systems. However, it is also desirable to integrate such legacy systems with other legacy systems that have incompatible formats. For an integration to be practical, it must be relatively inexpensive. In addition, it must overcome challenges related to disparate doctor identifiers and patient identifiers used in the different systems. Further, it must support message exchanges between legacy systems that require different message formats. In addition, such a solution should provide a comprehensive audit trail of messages that traverse between legacy systems.

### SUMMARY OF THE INVENTION

An electronic medical record system includes a first electronic medical record system to store a complete medical record for a patient. An electronic medical record appliance is connected to the first electronic medical record system. The electronic medical record appliance includes a medical information exchange consent policy module including instructions executed by a processor to supply to the patient a medical information exchange consent policy interface with selectable medical information exchange consent policy elements, receive selected medical information exchange consent policy elements from the patient, accept from a second electronic medical record system a medical record request for the patient, filter the complete medical record for the patient in accordance with the selected medical information exchange consent policy elements to form a consent filtered medical record and transfer the consent filtered medical record to the second electronic medical record system.

A method includes storing a complete medical record for a patient, supplying to the patient a medical information exchange consent policy interface with selectable medical information exchange consent policy elements, receiving selected medical information exchange consent policy elements from the patient, accepting a medical record request for the patient, filtering the complete medical record for the patient in accordance with the selected medical information exchange consent policy elements to form a consent filtered medical record and transferring the consent filtered medical record.

An electronic medical record apparatus includes a medical information exchange consent policy module including instructions executed by a processor to supply to a patient a medical information exchange consent policy interface with selectable medical information exchange consent policy elements, receive selected medical information exchange consent policy elements from the patient, accept a medical record request for the patient, filter a complete medical record for the patient in accordance with the selected medical information exchange consent policy elements to form a consent filtered medical record and transfer the consent filtered medical record.

### BRIEF DESCRIPTION OF THE FIGURES

The invention is more fully appreciated in connection with the following detailed description taken in conjunction with the accompanying drawings, in which:

FIG. 1 illustrates an electronic medical record exchange system configured in accordance with an embodiment of the invention.

FIG. 2 illustrates an appliance or gateway configured in accordance with an embodiment of the invention.

FIG. 3 illustrates the establishment of master indices in accordance with an embodiment of the invention.

FIG. 4 illustrates record audit trail and normalization operations performed in accordance with an embodiment of the invention.

FIG. 5 illustrates a record audit trail supplied in accordance with an embodiment of the invention.

FIG. 6 illustrates a record audit trail supplied in accordance with another embodiment of the invention.

FIG. 7 illustrates an appliance or gateway configured in accordance with an embodiment of the invention.

FIG. 8 illustrates medical information exchange consent policy processing operations associated with an embodiment of the invention.

FIG. 9 illustrates a user interface to implement a medical information exchange consent policy in accordance with an embodiment of the invention.

Like reference numerals refer to corresponding parts throughout the several views of the drawings.

### DETAILED DESCRIPTION OF THE INVENTION

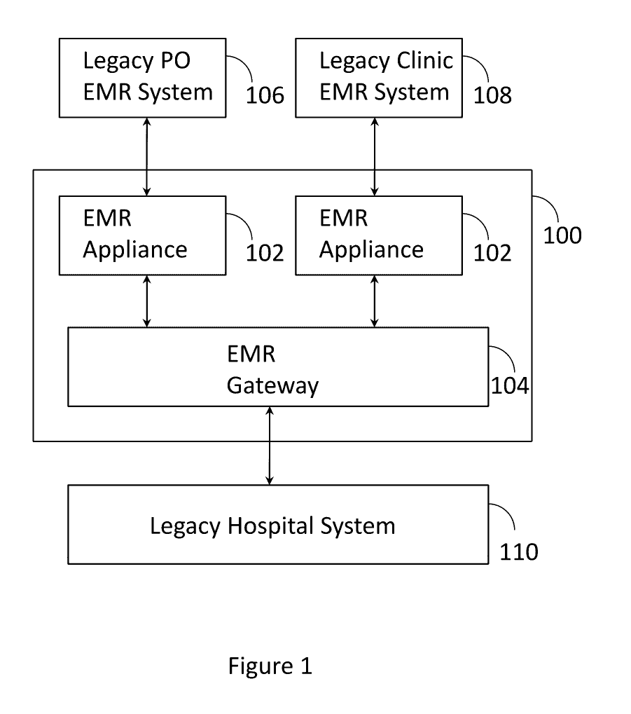

FIG. 1 illustrates an electronic medical record (EMR) exchange system 100 configured in accordance with an embodiment of the invention. The system 100 includes a set of EMR appliances 102. Each EMR appliance 102 is a hardware platform designed to provide an EMR computing resource. An appliance is a closed and sealed system that is not serviceable by a user. Thus, it stands in contrast to a general purpose computer, where a user can modify the hardware configuration and load any type of software desired. An appliance has a limited interface, usually a terminal console or web-based, to allow limited configuration operations. The EMR appliance is desirable because it effectively runs on its own, thereby reducing IT expenses. Automated back-up, software control and maintenance are done behind the scenes, eliminating headaches like software installation, conflicts and updates. The EMR appliance also provides protection from viruses, hackers or other threats to security. Thus, the EMR appliance reduces initial capital costs and ongoing maintenance costs.

Each EMR appliance 102 is connected to an EMR gateway server 104. The EMR gateway server 104 is a general purpose computer implementing operations of the invention. The EMR appliances 102 and EMR gateway server 104 operate as an EMR exchange system 100 to provide interoperability with legacy EMR systems. For example, a first EMR appliance may be connected to a legacy physician's office EMR system 106, while another EMR appliance 102 may be connected to a legacy medical clinic EMR system 108. The EMR gateway server 104 may be connected to a legacy hospital EMR system. In general, an EMR appliance 102 is used in connection with a relatively small legacy EMR system, while an EMR gateway 104 is used in connection with a relatively large legacy EMR system. The system 100 may be configured with additional EMR appliances and EMR gateways 104.

The EMR exchange system 100 uses its internal components (102, 104) to communicate in a domain with common doctor and patient identifiers that are different than the doctor and patient identifiers utilized in the legacy EMR systems. The EMR exchange system 100 also provides an end-to-end audit trail of messages exchanged between legacy EMR systems. In addition, the EMR exchange system 100 transforms incompatible message formats utilized by different EMR legacy systems to provide compatibility between the different EMR legacy systems.

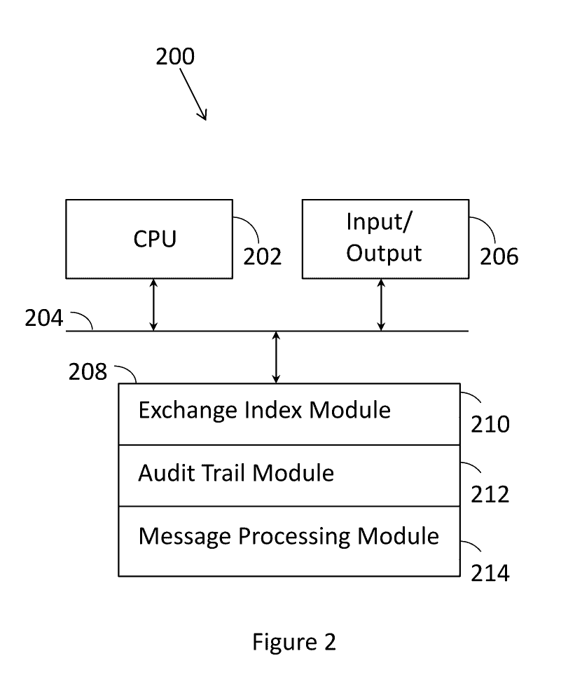

FIG. 2 illustrates a computation device 200 configured in accordance with an embodiment of the invention. The computation device 200 may be configured as an EMR appliance 102 or an EMR gateway server 104. In the case of an EMR gateway server 104, standard server components are used, such as a central processing unit 202 and input/output devices 206 connected by a bus. The input/output devices 206 may include a keyboard, mouse, display, printer and the like. A memory 208 is also connected to the bus. The memory 208 includes executable instructions to implement operations of the invention. In one embodiment, the memory 208 includes an exchange index module 210. The exchange index module 210 includes executable instructions to assign doctor and patient identifiers that are used within the EMR exchange system 100. This allows the EMR exchange system 100 to efficiently identify and process doctor and patient records within the system 100, while still being compatible with legacy systems that use different doctor and patient identifiers.

The memory 208 also includes an audit trail module 212. The audit trail module 212 includes executable instructions to provide end-to-end tracking of a message passed through the EMR exchange 100, as discussed below.

The memory 208 also includes a message processing module 214. The message processing module 214 includes executable instructions to transform incompatible message formats from different legacy systems into a format that can be used by different legacy systems, as discussed below.

The operations of modules 210, 212 and 214 are also implemented in each EMR appliance 102. Thus, an EMR appliance 102 may have a similar configuration to device 200. However, the appliance 102 will typically omit the input/output devices 206. Further, the appliance 102 may implement its operations through an Application Specific Integrated Circuit or other custom hardware instead of a general purpose central processing unit. Regardless of the appliance configuration, it operates in conjunction with the EMR gateway 104 to provide patient and doctor identifiers, audit trail tracking and message processing. These operations are distributed between an EMR appliance 102 and an EMR gateway 104, as discussed below.

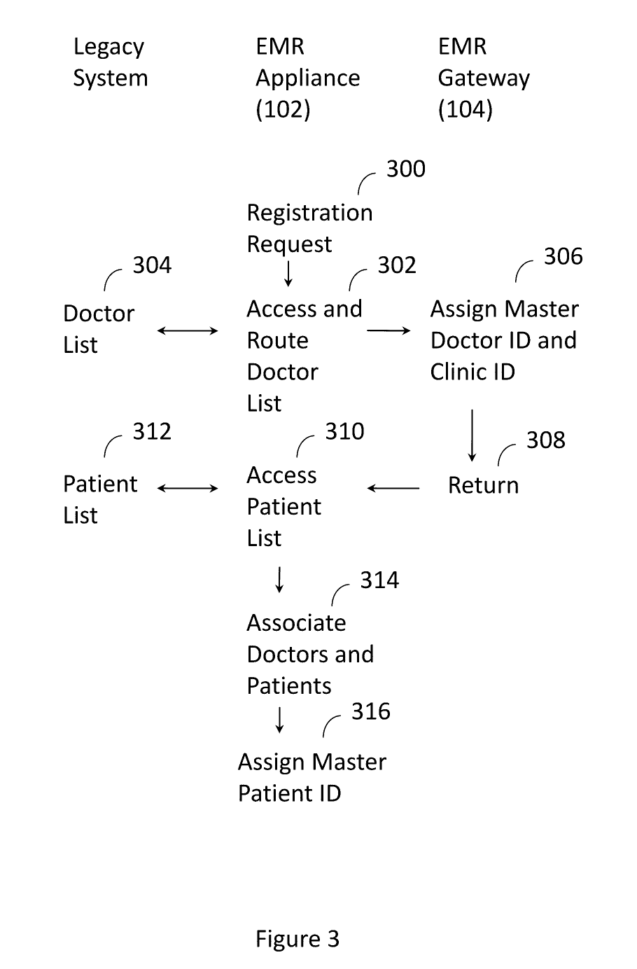

FIG. 3 illustrates operations associated with assigning master doctor and patient identifiers in accordance with an embodiment of the invention. The figure illustrates operations performed across various machines, including a legacy system, an EMR appliance 102 and an EMR gateway 104.

A legacy system, such as a system at a hospital or a clinic, includes a physician and patient database. The identifier for a patient or a physician at one legacy system (e.g., a hospital) could be different than the identifier at another legacy system (e.g., a clinic).

When the EMR appliance 102 is initially activated, it generates a registration request 300. The registration request 300 initiates an access to a list of doctors 304 in a legacy system. The list of doctors is then routed 302 to the EMR gateway 104. The EMR gateway 104 assigns a master doctor identifier to each doctor on the list. This master doctor identifier is used within the medical record exchange system 100. A clinic identifier may also be assigned to the doctor so that a doctor operating at different clinics can be uniquely identified and coordinated with appropriate patients. The master doctor identifier is then returned 308 to the EMR appliance 102. This causes the EMR appliance 102 to access 310 a patient list 312 within the legacy system. The EMR appliance 102 associates doctors and patient 314. Thereafter, the EMR appliance 102 assigns master patient identifiers 316 to each patient. Each master patient identifier is used within the EMR exchange system 100. Each master patient identifier is typically different than the patient identifier used in the legacy system.

From this point forward, any received EMR can be mapped from a legacy system identifier to a master identifier utilized within the EMR exchange system 100. For example, an EMR message utilizing the doctor identifier and patient identifier of legacy Physician Office EMR system 106 is mapped to the master doctor identifier and master patient identifier of the electronic medical record exchange system 100. The master doctor identifier and/or master patient identifier may then be mapped to a doctor or patient at legacy clinic EMR system 108.

Each master identifier is a unique value that has an associated list of values for legacy systems. For example, the master doctor identifier has a unique value. This unique value is associated with a list of doctor identifiers used for the same doctor at different offices, clinics, or hospitals. The same approach is used with the master patient identifier. The term “master” indicates a prevailing identifier in the electronic medical record exchange systems 100. However, it is not a “master” identifier across an entire EMR system. The use of a single “master” identifier across an entire EMR system implies centralized control, which is expensive and otherwise meets resistance for a variety of reasons. In contrast, the invention provides a distributed system that allows incompatible legacy systems to operate with one another.

If a message is received at the gateway 104, it is routed to an appliance 102 associated with a clinic or office that the doctor practices at. In other words, the message is routed in accordance with the master doctor identifier and clinic identifier. The appliance 102 can then link the master patient identifier with the patient identifier used by the legacy system. Consequently, the EMR exchange system 100 provides interoperability between legacy systems without synchronization between different databases.

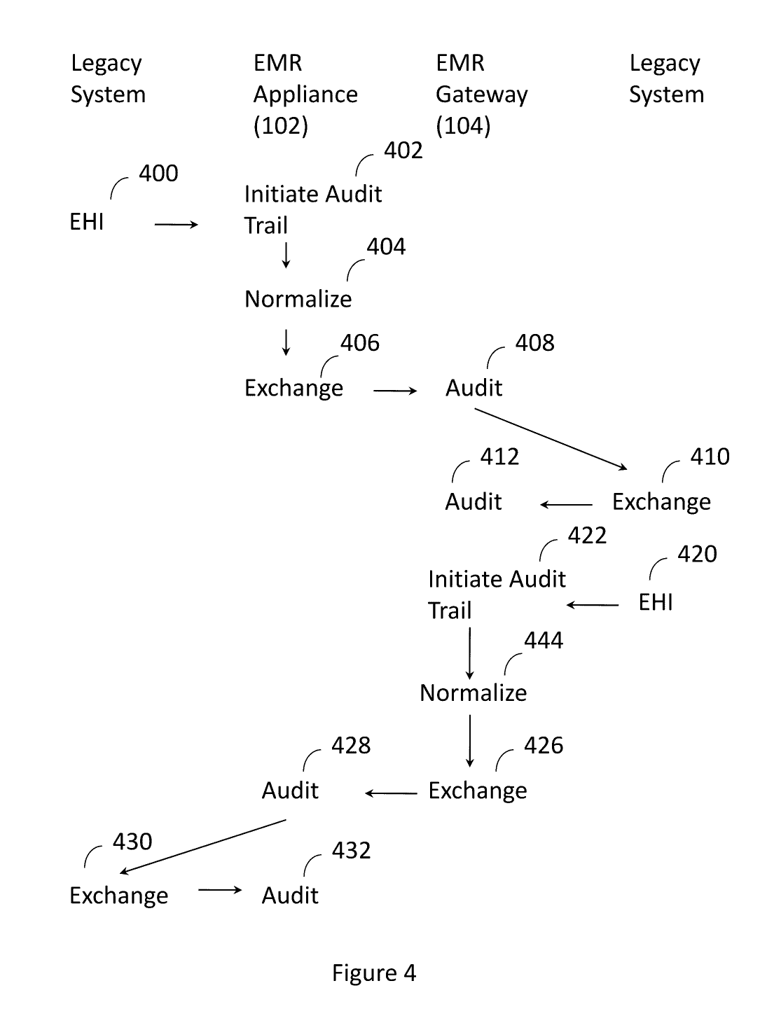

FIG. 4 illustrates audit trail processing performed in accordance with an embodiment of the invention. For example, a legacy system generates electronic health information (EHI) 400, which is passed to the EMR appliance 102. The electronic health information may be in form of an EMR. Receipt of the EHI at the EMR appliance 102 initiates an audit trail 402. Optionally, the message may be normalized 404 for compatibility with another legacy system. That is, a sender (e.g., a hospital) and a receiver (e.g., a clinic) may require different message formats. The sender and receiver can ignore these incompatibilities since they are handled by the EMR exchange system 100. The EMR appliance 102 or the EMR gateway 104 identifies the target system and then evaluates data conformance rules utilized by the target system. For example, a sent message may be in HL7 2.3 form. However, the recipient requires a 2.5 format. In this case, the appliance 102 invokes a script to convert the message from 2.3 to 2.5 before passing it on. Alternately, an HL7 message may have an outpatient code of “OP”. The receiving system may require a single character outpatient code. The appliance 102 utilizes a script to provide the appropriate format. Alternately, a message may have a segment unrecognized by the target system. In this case, the appliance deletes such a segment so that it can be processed at the target system.

After any required normalization, the message is then exchanged 406 with the EMR gateway 104. The message is audited 408 at the EMR gateway 104. At this point, the message would typically be directed toward another legacy system through another exchange 410. An acknowledgement from the legacy system may then be audited 412.

Alternately, an EHI 420 may be generated at another legacy system and be initially passed to the EMR gateway 104. In this case, the EMR gateway 104 initiates an audit trail 422. If necessary, the message is normalized 444. The message is then exchanged 426 to the EMR appliance 102, where it is audited 428. The message is then exchanged 430 to another legacy system. An acknowledgement from the legacy system may then be audited 432.

The audit trail allows for the tracking of the progress of messages. The audit trail can be used to certify that a message was properly acknowledged by a target receiving entity. The appliance 102 and gateway 104 may keep separate audit trails. Alternately, their audit trail information may be exchanged to produce comprehensive audit trail information.

The system generates a unique message identifier for each outgoing message. One message may be sent to several recipients. As a result, there is a 1-to-N mapping from an outgoing message identifier to an incoming message identifier. The unique identifier of the incoming message is associated with the outgoing message identifier for correlation.

An incoming message may not result in an outgoing message. In this case, a doctor identifier and clinic identifier may be used for audit purposes. A legacy system may require a doctor to be of a fixed type (e.g., attending physician) to receive a message. The EMR exchange system 100 may transform a doctor to a fixed type (e.g., from referring to attending) to enable receipt of a message. The audit trail may be used to preserve the original doctor type.

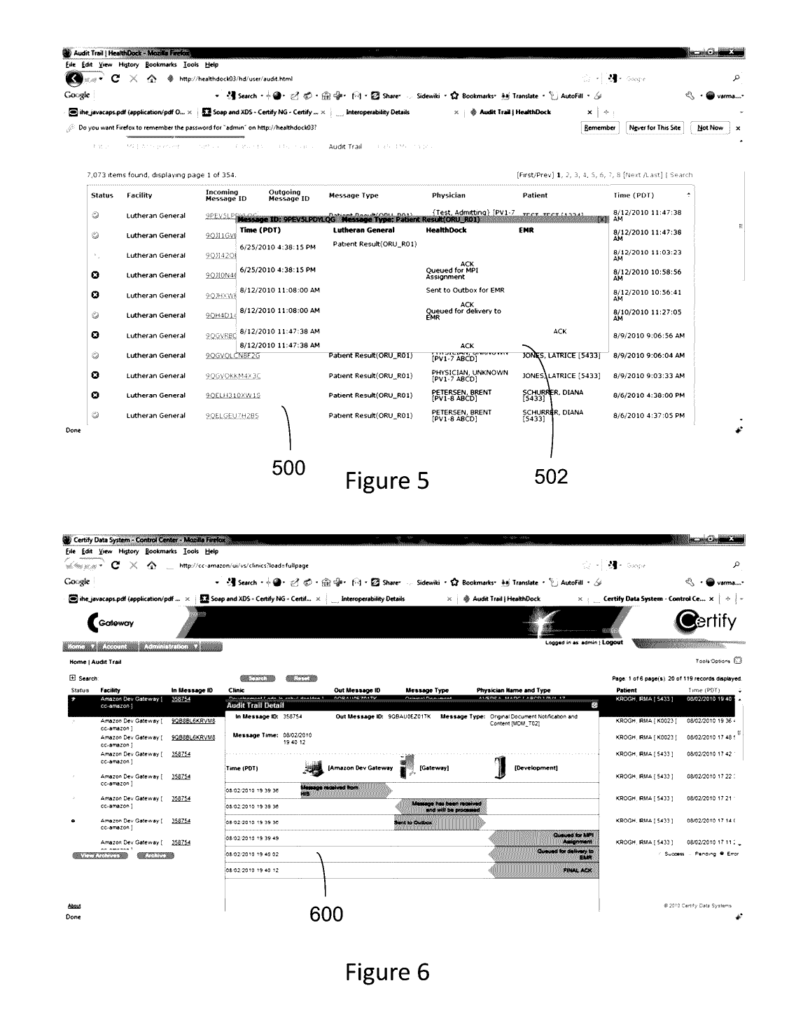

FIG. 5 illustrates an audit trail formed in accordance with an embodiment of the invention. Window 500 displays message information, including status information, incoming message ID, outgoing message ID, message type, physician, patient and time. Window 502 illustrates tracking of an individual message. In this example, a patient result is generated by a legacy system (Lutheran General) and is passed to EMR appliance 102 (Healthdock). The message is queued and then sent to the associated clinic legacy system (EMR). The receipt of the message is then acknowledged by the legacy system.

FIG. 6 illustrates a window with an audit trail that uses different shading or coloring to represent the status of a message. For example, one shade may be used for receipt of a message, another for queuing a message, another for sending a message, another for an initial acknowledgment and another for a final acknowledgment.

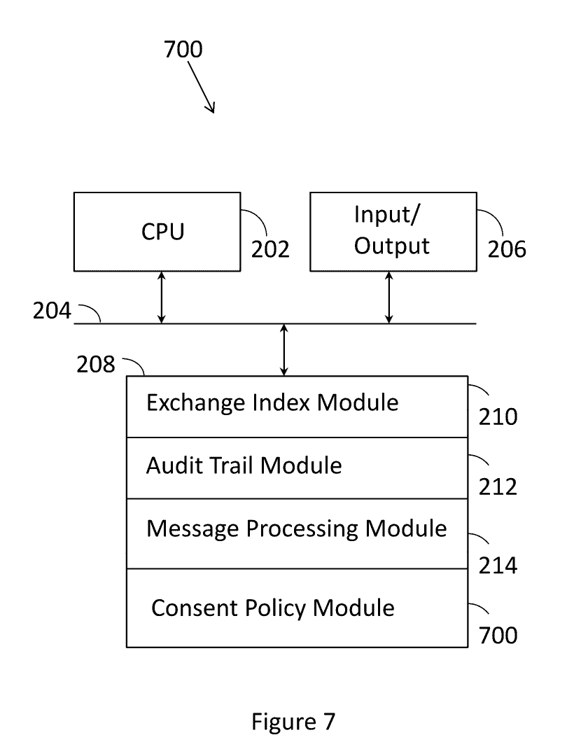

FIG. 7 illustrates a computation device 700 corresponding to the computation device of FIG. 2, but with an additional control module, namely, a consent policy module 700. The consent policy module 700 includes executable instructions to implement a medical information exchange consent policy. This allows a patient to control the dissemination of medical information about the patient.

Patient consent policies for a large health care system can vary by state, region or even by hospital facility. Currently, health care systems attempt to manage this process by convening a governing board which attempts to coerce all policies into a single set. Besides the large effort and time needed to align these policies, the resulting policies may not be understandable when presented back to an individual patient within a region.

Computation device 700 may be in the form of an EMR appliance 102 operative with other EMR appliances and an EMR gateway 104. The computation device 700 distributes consent management to local offices and enforces consent at the edges of the network, thereby removing the need for a single size fits all and global consent policy.

Consent policies are defined within a practice with specific rules about which criteria to search for with a health record and then what pieces of that health record should be redacted (if any). This is accomplished with a point and click interface. Thus, what once took months to accomplish can now be implemented almost instantaneously.

A patient is presented with a choice of consent policies to select from. The choice is entered into the system. From that point forward only the information appropriate to that policy is shown or shared with other systems within a health care system.

For example, one may be at a mental health clinic and not want a diagnosis or medication shared with a family physician at a home family practice. The mental health clinic would create a policy “Don't share mental health diagnosis”, indicate which codes should be considered mental health codes and then indicate that these should be removed, along with the Problems and Medications sections of the Clinical Document Architecture (CDA). CDA is an HL7 authored health care documentation standard.

When a family physician logs into her EMR appliance (e.g., through a legacy clinic EMR system 108) and views an integrated patient record she will see all of her local data and also the data from the connected EMR appliance at the mental health clinic, but with the Problems and Medications sections along with the specific mental health codes redacted.

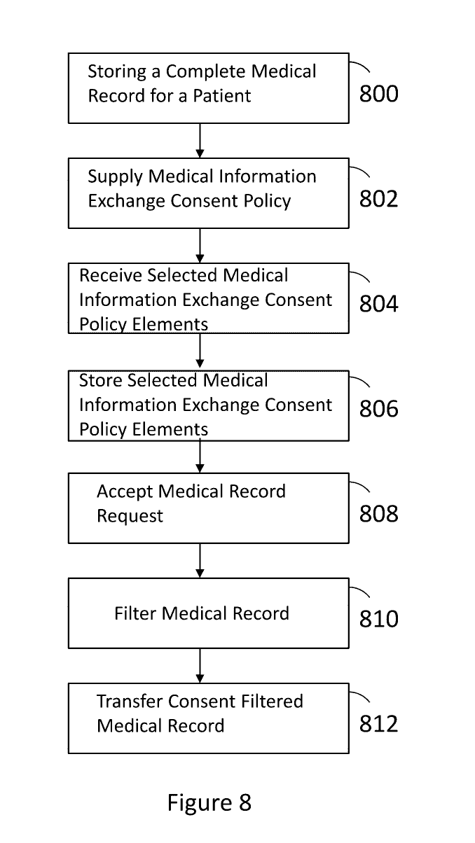

FIG. 8 illustrates processing operations associated with this embodiment of the invention. A complete medical record for a patient is stored 800. For example, this may be the complete medical record from the mental health clinic.

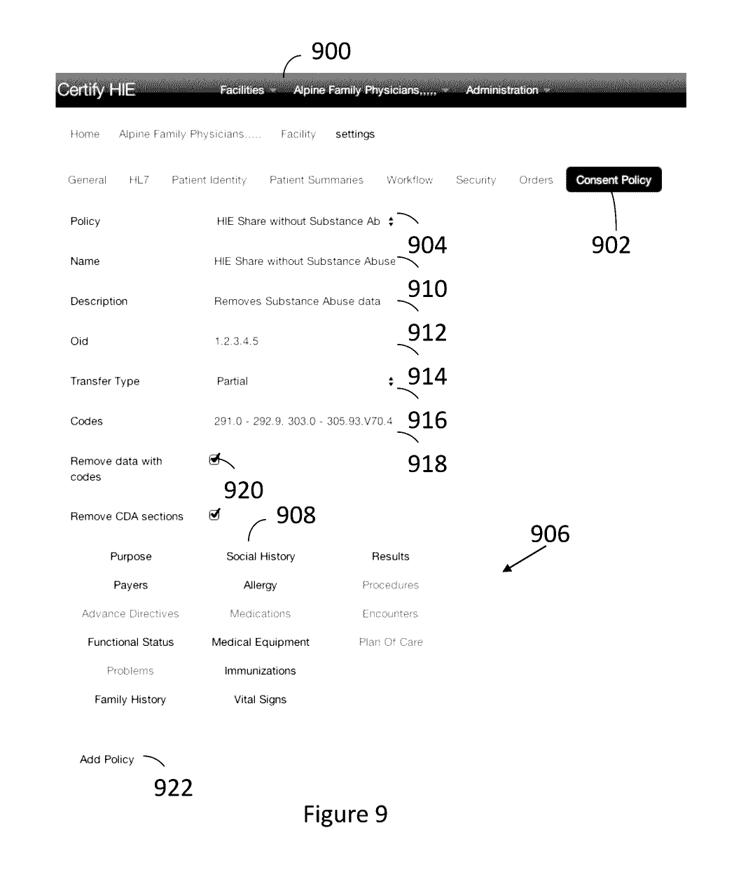

A medical information exchange consent policy is then supplied to the patient. An example of such a policy is discussed in connection with FIG. 9. Selected medical information exchange consent policy elements are then received 804. The selected medical information exchange consent policy elements are then stored 806. These elements may be stored in a legacy EMR system (e.g., legacy clinic EMR system 108) or at an EMR appliance 102.

Subsequently, a medical record request is accepted 808. For example, the family physician may request medical records for a patient from all EMR systems in a network. The medical records are filtered 810. More particularly, the medical records are filtered in accordance with the selected medical information exchange consent policy elements to form a consent filtered medical record. The consent filtered medical record is then transferred 812. For example, a consent filtered medical record may be transferred from the mental health clinic to the family physician.

FIG. 9 illustrates an exemplary medical information exchange consent policy user interface 900. The consent policy may be selected with button 902. A pull-down menu 904 may define various consent policy templates. Each template has pre-populated selected medical information exchange consent policy elements. For example, in the case of a substance abuse template, selected medical information exchange consent policy elements related to substance abuse are pre-populated.

Area 906 illustrates various selectable medical information exchange consent policy elements. In this example, the items are pre-populated for their relevance to substance abuse. Social history 908 is an example of a selectable medical information exchange consent policy element. Indicia (coloring, cross-hatching, font, etc.) may be used to indicate which elements are in force by default. The default elements may be maintained or overridden through user action. In addition to the default items, one or more additional selectable medical information exchange consent policy elements may be presented for selection.

Other features associated with the user interface 900 include a policy name, as shown with window 910. A layman description of the policy may be provided, as shown with window 912. Additional characteristics of the policy, such as its age 914 may be provided. The data transfer characteristics may also be characterized, as shown with window 916. Implicated CDA codes may also be listed, as shown with window 918.

The interface 900 may also allow one to select the removal of data for the specified codes of block 918, as shown with item 920. After the elements of user interface 900 are manipulated, the policy may be invoked through activation of button 922. Thereafter, a complete medical record will be filtered in accordance with the specified consent policy.

Advantageously, the consent policy is enforced at the local EMR appliance 102. Known systems send all medical information and the consent policy the data consumer should use. This approach relies upon the assumption that the recipient of the medical information will conform to the policy. Unfortunately, the recipient may inadvertently share this data without the related consent policy or may share with another system that doesn't understand what the policy means and how the rules should be applied.

In contrast, the disclosed system redacts the information and then it can be shared as needed. The policy has already been enforced. This facilitates a much more flexible, quickly deployed consent policy. In addition, this approach has higher security due to local enforcement of the policy.

One may create a policy and mark it as the default for a given clinic or set of clinics based on geography. This is useful for large healthcare systems that may have different laws in different states for health information exchange sharing of data. For example, one can implement the same set of policies but mark one of those policies as the default in Georgia clinics and a different policy as the default in Florida clinics. Patients still have the ability to actively select the other policies as defined by the health care system.

The consent policy system also supports the ability to define different consent policies per clinic, if desired. This allows health care systems to rollout consent management in a regional way, which is more resource friendly for program management. This avoids the “Big Bang” approach of monolithic consent management where all locations must first agree on a single set of policies.

Observe that the disclosed decentralized consent policy management technique avoids the problem of delivering a full medical record along with a consent policy and the concomitant hope that the recipient applies the consent policy. Rather, the recipient only receives the information that the patient has specified that the recipient can receive. Accordingly, there is no opportunity for the recipient to misuse full medical record information.

In an embodiment of the system, the recipient does not store a received consent filtered medical record. Rather, if the recipient requires the record again, a new request is made. This has the advantage that a patient can subsequently alter a consent policy and know that the new consent policy will be applied when a medical professional accesses medical information. This approach is also advantageous since it reduces data proliferation.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1-14. (canceled)

15. A method, comprising:
storing a medical record for a patient;
supplying to the patient from an electronic medical record appliance a medical information exchange consent policy interface with selectable consent policy templates;
receiving a selection of a consent policy template;
pre-populating selectable medical information exchange consent policy elements in accordance with the selection to form pre-populated selectable medical information exchange consent policy elements, each of the medical information exchange consent policy elements:
(1) corresponding to at least one section of the medical record; and
(2) comprising a redaction indicator applicable to all medical record requesters;
receiving from the patient override actions for individual pre-populated selectable medical information exchange consent policy elements to form individual pre-populated selectable medical information exchange policy elements and overridden individual selectable medical information exchange policy elements wherein each override action is a selection or deselection of a redaction indicator;
accepting at the electronic medical record appliance from a plurality of medical record requesters a medical record requests for the patient;
filtering at the electronic medical record appliance the medical record for the patient in accordance with the individual pre-populated selectable medical information exchange policy elements and overridden individual selectable medical information exchange policy elements to form a consent filtered medical record wherein sections of the medical record are redacted according to an applicable redaction indicator; and
transferring from the electronic medical record appliance to each medical record requester the consent filtered medical record in response to the medical record request.

16. The method of claim 15 wherein each selectable consent policy template is based upon a different medical condition.

17. The method of claim 15 wherein each selectable consent policy template is based upon geography.

18. The method of claim 15 wherein each selectable consent policy template is based upon a clinic.
